(19) United States
(12) Patent Application Publication
(10) Pub. No.: US 2024/0202752 A1
(43) Pub. Date: Jun. 20, 2024

(54) DISTRIBUTED ENERGY RESOURCES MANAGEMENT SYSTEM SOFTWARE PLATFORM

(71) Applicant: IEMS Solution Ltd, Kitchener (CA)

(72) Inventors: Ashkan Rahimi-Kian, Kitchener (CA); Masoud Bashari, Kitchener (CA); Javad Zare, Kitchener (CA); Ehsan Saradar-Torshizi, Kitchener (CA); Kaveh Aflaki, Suwanee, GA (US)

(73) Assignee: IEMS Solution Ltd, Kitchener (CA)

(21) Appl. No.: 18/511,889

(22) Filed: Nov. 16, 2023

Related U.S. Application Data
(60) Provisional application No. 63/432,419, filed on Dec. 14, 2022.

(51) Int. Cl. G06Q 30/0202

(52) U.S. Cl. CPC G06Q 30/0202

(57) ABSTRACT

An energy resource distribution management system engine is implemented with optimal power flow algorithm. At least one forecasting artificial neural network module is provided. At least one database, wherein the database comprises a historical database and an application specific database is provided. The forecasting artificial neural network module performs mathematical modeling on data received from the database to generate at least one forecasted data.

### CROSS REFERENCE TO RELATED APPLICATION

This application claims the benefit under 35 U.S.C. § 119(e) of co-pending U.S. Provisional Application No. 63/432,419 entitled “DISTRIBUTED ENERGY RESOURCES MANAGEMENT SYSTEM SOFTWARE PLATFORM” filed Dec. 14, 2022, which is incorporated herein by reference.

### BACKGROUND

With the growth of distributed renewable energy resources, electric vehicle (EV) charging stations and EV-fleets are experiencing a corresponding need for new resources and expanded loads. The need to connect to the power distribution grids increases over time. However, the current power distribution grids do not have the software infrastructure for modernized resource management required by the new demands. As a result, there exists a need for a robust software as a service (Saas) infrastructure that is capable of simultaneously handling data collection, predictive analytics, real-time optimization and control of these new energy resources and loads.

### SUMMARY

The following summary is provided to introduce a selection of concepts in a simplified form that are further described below in the detailed description. This summary is not intended to identify key features or essential features of the claimed subject matter, nor is it intended to be used to limit the scope of the claimed subject matter.

In various implementations, an energy resource distribution management system with predicative analysis capabilities is provided. An energy resource distribution management system engine is implemented with optimal power flow algorithm. At least one forecasting artificial neural network module is provided. At least one database, wherein the database comprises a historical database and an application specific database is provided. The forecasting artificial neural network module performs mathematical modeling on data received from the database to generate at least one forecasted data.

In other implementations, a method for forecasting energy resource distributions is provided. An energy resource distribution management system engine with optimal power flow algorithm is implemented. The engine is connected to at least one forecasting artificial neural network module. At least one database, wherein the database comprises a historical database and an application specific database, is connected to the engine. Mathematical modeling is utilized on data received from the database to generate at least one forecasted data.

These and other features and advantages will be apparent from a reading of the following detailed description and a review of the appended drawings. It is to be understood that the foregoing summary, the following detailed description and the appended drawings are explanatory only and are not restrictive of various aspects as claimed.

### BRIEF DESCRIPTION OF THE DRAWINGS

FIG. 1 is an embodiment of an exemplary distributed energy resources management system platform.

FIG. 2 is an exemplary process for training the distributed energy resources management system for photovoltaic generation forecast.

FIG. 3 is an exemplary process for training the distributed energy resources management system for electric load forecast.

FIG. 4 is an exemplary process for training the distributed energy resources management system for EV demand and generation forecast.

FIG. 5 is an exemplary structure of the data engineering and machine learning engineering components of the distributed energy resources management system.

FIG. 6 is a block diagram of a cloud-based computing system operable to execute the disclosed systems and methods in accordance with this disclosure.

FIG. 7 is a block diagram of a computing system operable to execute the disclosed systems and methods in accordance with this disclosure.

### DETAILED DESCRIPTION

The subject disclosure is directed to novel software/SaaS platforms for data collection and for forecasting short-term loads for power grids, EV-fleet charge demand, and photovoltaic (PV) and wind generation that utilizes blockchain-based transactive energy (TE) technology. The platform can forecast 5-minutes to 1-hour ahead for a grid to provide optimization of resources and scheduling. The platform can be overcome the above-mentioned challenges. The disclosed system is appropriate for the smart grid operators, i.e., power utilities, power distribution companies (distributor system operator), microgrid operators, smart/green buildings' energy managers, EVSE (Electric Vehicle Supply Equipment) firms and EV-fleet.

The detailed description provided below in connection with the appended drawings is intended as a description of examples and is not intended to represent the only forms in which the disclosed examples can be constructed or utilized. The description sets forth functions of the examples and sequences of steps for constructing and operating the examples. However, the same or equivalent functions and sequences can be accomplished by different examples.

References to “one embodiment,” “an embodiment,” “an example embodiment,” “one implementation,” “an implementation,” “one example,” “an example” and the like, indicate that the described embodiment, implementation or example can include a particular feature, structure or characteristic, but every embodiment, implementation or example can not necessarily include the particular feature, structure or characteristic. Moreover, such phrases are not necessarily referring to the same embodiment, implementation or example. Further, when a particular feature, structure or characteristic is described in connection with an embodiment, implementation or example, it is to be appreciated that such feature, structure or characteristic can be implemented in connection with other embodiments, implementations or examples whether or not explicitly described.

References to a “module”, “a software module”, and the like, indicate a software component or part of a program, an application, and/or an app that contains one or more routines. One or more independently modules can comprise a program, an application, and/or an app.

References to “Internet of Things” or “IoT” shall refer to smart systems and/or devices comprised of physical objects that are embedded with sensors, processing ability, software, and other technologies, and that connect and exchange data with other devices and systems over the Internet or other communications networks. The systems can represent a convergence of multiple technologies, including ubiquitous computing, commodity sensors, increasingly powerful embedded systems, and machine learning.

Numerous specific details are set forth in order to provide a thorough understanding of one or more embodiments of the described subject matter. It is to be appreciated, however, that such embodiments can be practiced without these specific details.

Various features of the subject disclosure are now described in more detail with reference to the drawings, wherein like numerals generally refer to like or corresponding elements throughout. The drawings and detailed description are not intended to limit the claimed subject matter to the particular form described. Rather, the intention is to cover all modifications, equivalents and alternatives falling within the spirit and scope of the claimed subject matter.

In general, a distributed energy resource management system with a predictive software platform is provided. The software platform comprises a predictive analytics (PA) module, which uses deep neural networks (DNN), irradiation, meteorological and historical data as input and provides per unit forecasted photovoltaic generation (PV) and electric loads for the upcoming 24 hours. In various embodiments, more forecast analysis can be performed per application need.

The platform leverages novel algorithms and software/SaaS platforms for data collection, communication, and data engineering services. The platform collects data from Advanced Metering Infrastructure (AMI) comprising smart meters, IoT devices, and also the weather data collection devices. The platform provides Deep Neural Network based Predictive Analytics SaaS for short-term (5-minute to one-hour) prediction of electric grid's load, EV charging demand, PV and Wind power generation forecasts.

The distributed energy resources management system (DERMS) software platform is used to model and optimally control/dispatch a group of distributed energy resource (DER) assets such as wind turbines, PV solar panels, battery energy storage systems (BESS), demand response (DR), and fleet of electric vehicles (EVs) to deliver vital grid services to help power utilities (PUs) to achieve mission-critical outcomes.

In various embodiments, the distributed energy resource management platform can be customized to fit different types of resource managements, including solar photovoltaic, wind, combined heat and power, diesel, and more. The disclosed platform is enabled through innovative math modeling. In various embodiments, the disclosed software platform engine is capable of optimal power flow (OPF) analysis with different objective functions.

A DERMS engine generates OPF analysis with different objective functions such as minimizing the energy cost (or price tariff) for the grid stake holders (i.e., suppliers, consumers and prosumers of energy), minimizing the network losses, peak-shaving, VVO (volt-var optimization) and minimizing the network load curtailment during network contingencies.

The DERMS platform generates outputs in form of CSV report and interactive network graphs with useful information to the user (i.e., grid planner and operator).

The platform provides energy resources optimization and (sub)-hourly scheduling using a non-linear programming based OPF combined with AI-based network clustering method for fast computations. This software is called DERMS.

The IEMS's DERMS and OPF modules have been developed using Python programming language within the Pandapower software, which is an open-source power system simulator. Further, all novel dynamic mathematical models of distributed energy resources (DER), flexible loads and demand response (DR) and electric vehicle supply equipment (EVSE types L1, L2 and L3) and fast optimization and model predictive control algorithms are designed and developed by IEMS.

The platform further determines near real-time optimization of a transmission and distribution (T&D) grids' generating resources and flexible loads with different objective functions. In various embodiments, these objective functions can include but are not limited to: cost, network loss, peak load shaving, peak load leveling, volt-var optimization (VVO), and conservative voltage reduction (CVR).

The platform leverages a hybrid neural network model with long short-term memory (LSTM) and deep feedforward network (DFNN) for forecasting electric load and PV generation by using historical, meteorological and irradiation parameters.

The disclosed platform is a TE platform within the cloud computing platforms for smart-grids with vehicle-to-grid (V2G) and grid-to-vehicle (G2V) services. The invented platform improves the electric distribution network reliability, stability, efficiency. The disclosed platform helps the grid operators make the power network more environment friendly by significantly reducing greenhouse gas via optimal utilization of clean energy resources. Further, the disclosed platform provides financial benefits for the EV drivers, EV serving entities (EVSE), and demand response (DR) aggregators.

One embodiment of the platform includes a hybrid neural network model with long short-term memory (LSTM) and deep feedforward network (DFNN) for forecasting electric load and PV generation by using historical, meteorological and irradiation parameters. The embodiment also includes fast and normal EV charging stations that are completely compatible with existing EV batteries; third, scalable Proof of Reputation (POR) energy blockchain with off-chain Know-Your-Customer (KYC); and finally, two-level Stackelberg game (or leader-follower game) formulation and optimization to find the stable Economic Game equilibrium between the grid operator and energy aggregators; and that for the energy aggregators and prosumers.

The software architecture is scalable, secure, and deployable within all cloud platforms (i.e., AWS, MS Azure, Google and IBM).

The disclosed system provides a DERMS software platform. The DERMS software platform is used to model, control and dispatch at least a group of distributed energy resource assets. The distributed energy resource assets can include wind turbines, PV solar panels, battery energy storage systems (BESS), demand response (DR), and electric vehicles fleets. The disclosed software platform is utilized to deliver vital grid services to help power utilities to achieve mission-critical outcomes.

The distributed energy resource management platform can be customized to fit different types of resource managements, including solar photovoltaic, wind, combined heat and power, diesel, and more.

The platform is enabled through innovative math modeling. In various embodiments, the disclosed software platform engine is capable of OPF analysis with different objective functions. In some embodiments, the functions can include energy cost (or price tariff) minimization for the grid stake holders minimizing the network losses, peak-shaving, volt-var optimization (VVO), and network load curtailment minimization during network contingencies. In an exemplary embodiment, the disclosed platform generates output in the formats that include comma separated values (CSV) report and interactive network graphs. The network information and key parameters within the CSV reports can include bus/node voltages, line currents, line power flows, bus/node power injection/consumption, nodal energy prices (DLMP), EV charging/discharging power/energy, greenhouse gas (GHG) reduction, lines and network power losses.

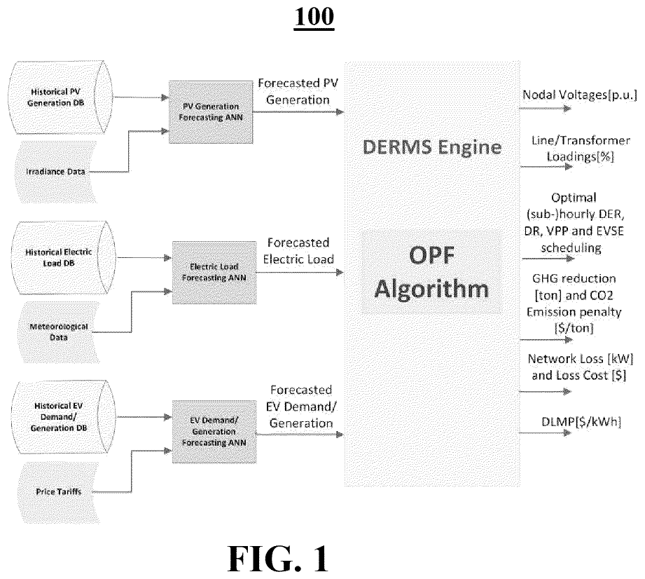

Referring to the drawings and, in particular, to FIG. 1, an exemplary flow diagram, generally designated by the numeral 100, of the DERMS software platform is illustrated. The exemplary flow diagram 100 illustrates a software platform that can utilize historical data and input to generate predicative forecast data for various applications in energy resource management.

The software platform can be implemented throughout a network that connects the relevant nodes for services in this field, such that the software installed and utilized by each pertinent device on the network would be able to carry out functions enabled thereon. It should be understand that the platform can be implemented in language, format, and construction that is most appropriate to the operating system of each device and node on the network.

As shown in FIG. 1, a DERMS engine is implemented into the platform. In the exemplary embodiment, the outputs can include nodal voltage, line/transformer loading, optimize hourly scheduling (including distributed energy resources, demand response, virtual power plant, electrical vehicle service entities, etc.), greenhouse gas reduction and CO₂ emission penalty, network loss and loss cost, and distribution locational marginal pricing.

The DERMS engine is provided with OPF algorithm. The OPF algorithm is designed to perform objective functions that would generate at least one of the outputs listed above. The particular need of each stakeholder of the platform would have specific requirements and inputs, and the DERMS engine would assign the appropriate objective function through the OPF algorithm for individualized analysis.

In the exemplary embodiment, three forecasting artificial neural networks (ANNs) are provided to utilize the DERMS engine. The disclosed system can perform predicative analysis on PV generation forecast, electric load forecast, and EV demand and generation forecast. In other embodiments, additional artificial neural networks and functions can be implemented through the DERMS engine. It is contemplated that, as the changing needs of EV energy management system evolves, new and varied factors and predictive metrics would be analyzed through adapted embodiments of the disclosed platform.

Each of the analytical neural network module comprises inputs to perform the necessary analysis for forecasting purposes. In the PV generation forecasting module, a historical PV generation database is provided along with an irradiance database. The PV generation forecasting module would query data from both databases to generate an input and an instruction for the distributed energy resource management system engine. The engine in turn would utilize the OPF algorithm to generate one of the outputs. In the exemplary embodiment, a forecasting function for PV generation can require relevant output of optimal hourly distributed energy resources scheduling, among others.

In the electric load forecasting module, a historical electric load database is provided along with a meteorological database. The electric load forecasting module would query data from both databases to generate an input and an instruction for the distributed energy resource management system engine. The engine in turn would utilize the OPF algorithm to generate one of the outputs. In the exemplary embodiment, a forecasting function for electric load can require relevant output of line/transformer loading, among others.

In the EV demand and generation forecasting module, a historical EV demand and generation database is provided along with a price tariff database. The EV demand and generation forecasting module would query data from both databases to generate an input and an instruction for the distributed energy resource management system engine. The engine in turn would utilize the OPF algorithm to generate one of the outputs. In the exemplary embodiment, a forecasting function for EV demand and generation can require relevant output of optimal distribution locational marginal pricing, among others.

For each of the data inputs, the disclosed system provides a number of methods for obtain these inputs. In an exemplary embodiment, the platform collects data from advanced metering infrastructure (AMI) comprising smart meters, internet of things (IOT) devices, and weather collection devices. These meters and devices can be connected through the metering infrastructure with the other components of the disclosed platform through cloud computing network, in some embodiments. The connection methodology can be modified and adapted for application specific infrastructure demands.

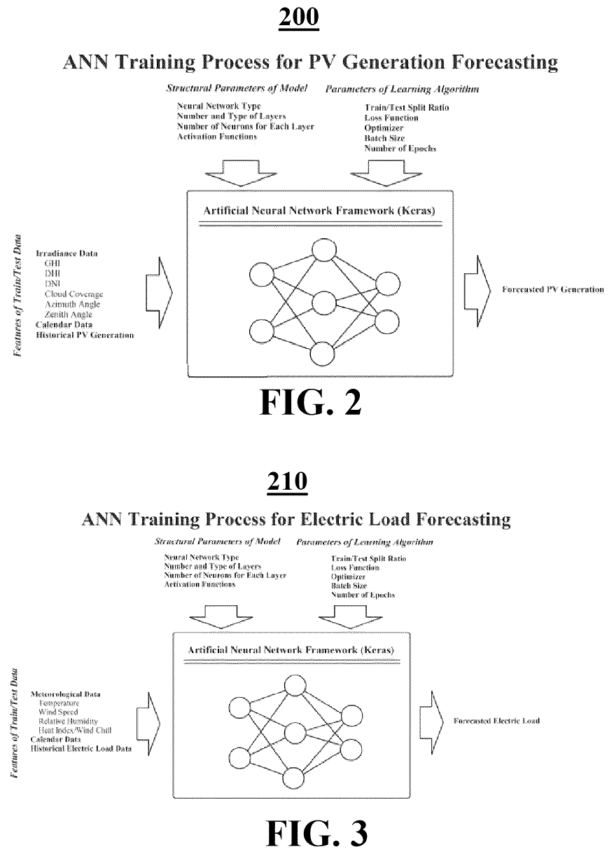

Referring to FIG. 2 with continuing reference to the foregoing figures, an exemplary process, generally designated by the numeral 200, for training an artificial neural network for PV generation forecasting is shown. The PV generation forecasting ANN can be implemented as the PV generation forecasting ANN in the software architecture in FIG. 1. In the exemplary embodiment, an artificial neural network frame is constructed with Keras. In other embodiments, the artificial neural network frame can be constructed and adapted with other software coding libraries or engines that is capable of processing deep learning training and analysis.

Keras is an open-source software library that provides a Python interface for artificial neural networks. Keras acts as an interface for the TensorFlow library. See https://keras.io/.

In general, the artificial neural network receives inputs from the disclosed platform, as often provided by energy resource management stakeholders, and processes the historical data through a set of parameters specified by the stakeholders in order to generate forecasting data. In the exemplary embodiment, the inputs are features of training and test data, structural parameters of model, and parameters of a learning algorithm. The artificial neural network framework applies the appropriate parameters through processing of feature data, such that appropriate predicative analysis can be performed.

In the exemplary embodiment, features of train and test data would incorporate historical data and data that would form the basis for machine learning training. As the exemplary artificial neural network relates to PV data, the test data correspond to the particular analysis needs. In this embodiment, irradiance data can include global horizontal irradiance (GHI), diffuse horizontal irradiance (DHI), direct normal irradiance (DNI), cloud coverage, azimuth angle, and zenith angle. In addition, the artificial neural network framework will also receive calendar data and historical PV generation data.

The structural parameters of model can include neural network type, number and type of layers, number of neurons of each layer, and activation functions. Parameters of the learning algorithm can include train/test split ratio, loss function, optimizer, batch size, and number of epochs. The parameters listed herein are not exhaustive and conclusive, as additional and varied parameters can be provided depending on the particular need of each stakeholder and neural network framework. It should be understood that the disclosed artificial neural network framework can be adapted to fit a variety of analytic requirements for energy resource management entities.

In practice, the disclosed framework analyzes the test data in accordance to the structural and learning parameters set forth by stakeholders and users. In the process, the PV generation framework is trained to identify patterns and trends disclosed in the historical data in order to produce predicative analysis data. Then, the framework can generate output of forecasted PV generation data at specified time intervals pertinent for each application.

In an exemplary embodiment, the framework can be utilized as a part of a software as a service (SaaS) model for short term prediction of PV generation, where the prediction can be produced from five minutes to one hour in accordance to schedule. In various other embodiments, the framework can be adapted to support predictive analytics SaaS models over a variety of time intervals.

Referring to FIG. 3 with continuing reference to the foregoing figures, an exemplary process, generally designated by the numeral 210, for training an artificial neural network for electric load forecasting is shown. The electric load forecasting artificial neural network can be implemented as the electric load forecasting ANN in the software architecture in FIG. 1. In the exemplary embodiment, an artificial neural network frame is constructed with Keras. In other embodiments, the artificial neural network frame can be constructed and adapted with other software coding libraries or engines that is capable of processing deep learning training and analysis.

In general, the artificial neural network receives inputs from the disclosed platform, as often provided by energy resource management stakeholders, and process the historical data through a set of parameters specified by the stakeholders in order to generate forecasting data. In the exemplary embodiment, the inputs are features of training and test data, structural parameters of model, and parameters of learning algorithm. The artificial neural network framework applies the appropriate parameters through processing of feature data, such that appropriate predicative analysis can be performed.

In the exemplary embodiment, features of train and test data would incorporate historical data and data that would form the basis for machine learning training. As the exemplary artificial neural network relates to PV data, the test data correspond to the particular analysis needs. In this embodiment, meteorological data can include temperature, wind speed, relative humidity, head index, and wind chill data. In addition, the artificial neural network will also receive as input calendar data and historical electric load data.

Similar to the artificial neural network framework in FIG. 2, the structural parameters of model can include neural network type, number and type of layers, number of neurons of each layer, and activation functions. Parameters of learning algorithm can include train/test split ratio, loss function, optimizer, batch size, and number of epochs. The parameters listed herein are not exhaustive and conclusive, as additional and varied parameters can be provided depending on the particular need of each stakeholder and neural network framework. It is understood that a person with ordinary skills in the art would adapt the disclosed artificial neural network framework to fit a variety of analytic requirements for energy resource management entities.

In practice, the disclosed framework analyzes the test data in accordance to the structural and learning parameters set forth by stakeholders and users. In the process, the electric generation forecast training framework is trained to identify patterns and trends disclosed in the historical data in order to produce predicative analysis data. The framework can then generate output of forecasted PV generation data at specified time intervals pertinent for each application. In an exemplary embodiment, the framework can be utilized as a part of a software as a service (SaaS) model for short term prediction of electric load, where the prediction can be produced from five minutes to one hour in accordance to schedule. In various other embodiments, the framework can be adapted to support predictive analytics SaaS models over a variety of time intervals.

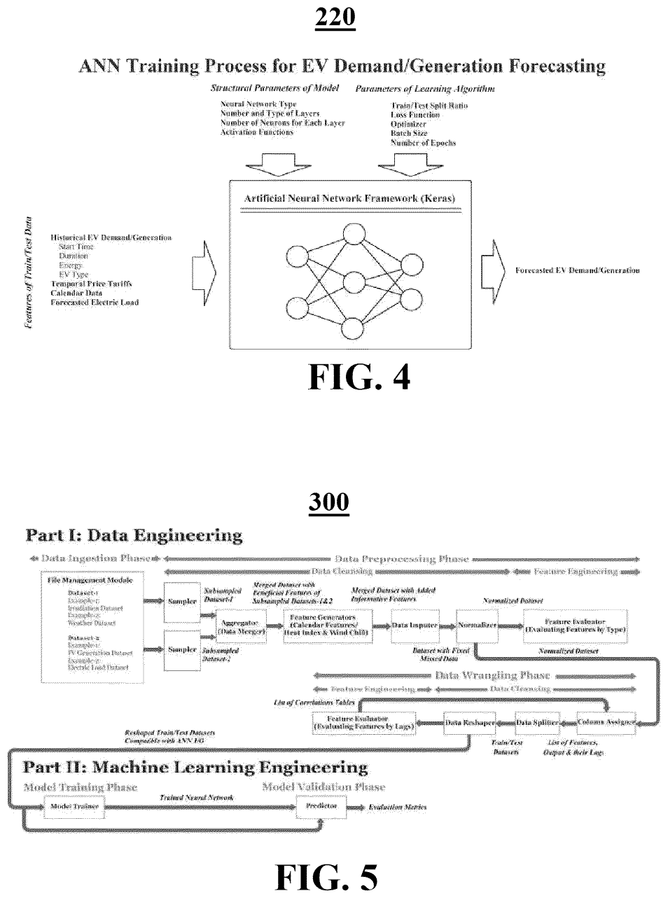

Referring to FIG. 4 with continuing reference to the foregoing figures, an exemplary process, generally designated by the numeral 220, for training an artificial neural network for EV demand and generation forecasting is shown. The EV demand and generation forecasting artificial neural network can be implemented as the EV demand and generation forecasting ANN in the software architecture in FIG. 1. In the exemplary embodiment, an artificial neural network frame is constructed with Keras. In other embodiments, the artificial neural network frame can be constructed and adapted with other software coding libraries or engines that is capable of processing deep learning training and analysis.

In general, the artificial neural network receives inputs from the disclosed platform, as often provided by energy resource management stakeholders, and process the historical data through a set of parameters specified by the stakeholders in order to generate forecasting data. In the exemplary embodiment, the inputs are features of training and test data, structural parameters of model, and parameters of learning algorithm. The artificial neural network framework applies the appropriate parameters through processing of feature data, such that appropriate predicative analysis can be performed.

In the exemplary embodiment, features of train and test data would incorporate historical data and data that would form the basis for machine learning training. As the exemplary artificial neural network relates to PV data, the test data correspond to the particular analysis needs. In this embodiment, historical electrical vehicle demand/generation data can include start time, duration, energy, and EV type data. Additionally, the features of train/test data can further include temporal price tariffs, calendar data, and forecasted electric load data.

The structural parameters of model can include neural network type, number and type of layers, number of neurons of each layer, and activation functions. Parameters of learning algorithm can include train/test split ratio, loss function, optimizer, batch size, and number of epochs. The parameters listed herein are not exhaustive and conclusive, as additional and varied parameters can be provided depending on the particular need of each stakeholder and neural network framework. It is understood that a person with ordinary skills in the art would adapt the disclosed artificial neural network framework to fit a variety of analytic requirements for energy resource management entities.

In practice, the disclosed framework analyzes the test data in accordance to the structural and learning parameters set forth by stakeholders and users. In the process, the framework is trained to identify patterns and trends disclosed in the historical data in order to produce predicative analysis data. The framework can then generate output of forecasted EV demand/generation data at specified time intervals pertinent for each application. In an exemplary embodiment, the framework can be utilized as a part of a software as a service (SaaS) model for short term prediction of PV generation, where the prediction can be produced from five minutes to one hour in accordance to schedule. In various other embodiments, the framework can be adapted to support predictive analytics SaaS models over a variety of time intervals.

Referring to FIG. 5 with continuing reference to the foregoing figures, an exemplary structure, generally designated by the numeral 300, for data and machine learning engineering associated with the DERMS is illustrated. These two exemplary parts can be implemented into the software engine to facilitate the forecasting function as illustrated in FIG. 2-4. In various embodiments, data engineering would be implemented to provide input data and parameters for artificial neural network training methodologies.

In general, data engineering aspect of the disclosed system would function through a number of phases. In an exemplary embodiment, data engineering comprises data ingestion phase, data processing phase, and data wrangling phase. The data process phase can further comprise of data cleansing and feature engineering. The data wrangling phase further incorporate feature engineering and data cleansing.

In the data ingestion phase, a file management module is provided. This can be implemented as a standalone database or as a part of a comprehensive database in larger system. FIG. 5 illustrates a number of datasets that could be stored in this management module. The dataset can be used to store and provide input for data used by the software engines shone in FIG. 2-4.

The data from the file management module can be extracted to go through the data process phase. In this exemplary phase, the data can go be processed through a data cleansing step. During this procedure, at least one sampler from a dataset in the file management module is collected by an aggregator or data merger. The aggregator provides the function to merge a number of datasets with their beneficial features.

Next, the merged datasets will be merged further with added informative features. This can be achieved by features generators. In this embodiment, the features generator can generate features on calendar features, heat index, and wind chill. The merged database with added informative features are processed through a data imputer and a normalizer. At this step, the datasets are transformed into normalized datasets.

Finally, the normalized dataset are processed through a feature engineering step. In the exemplary embodiment, a feature evaluator is provided to evaluate the features incorporated into the normalized dataset. The resultant data would be ready for further predicative processing in the software engine.

In various embodiments, normalized datasets can further be processed through a data wrangling phase in order refine the relevant features. The data wrangling phase will further comprise a data cleansing component and a feature engineering component. This is similar to the data processing phase, but with certain specific differentiators.

During the data cleans component of the data wrangling phase, the normalized datasets can be further processed through a column assigner, data splitter, and data reshaper. The column assigner applies a list of features, outputs, and their lags to the normalized datasets. The data splitter further provides train/test data to prepare the dataset to be in condition for machine learning module further in the process.

Finally, the feature evaluator finishes the data wrangling phase with its feature engineering function. In this exemplary phase, the datasets are evaluated by lags. The feature evaluator can further refer the dataset to the beginning of the data wrangling phase for another round of data processing. The resulting data set can be further applied through a column assigner again, which will further process the dataset through a datasplitter and a data reshaper. In various embodiment, data wrangling phase repeats as needed for the specific data forecast analytics.

The data reshaper has the ability to send the dataset to the next part of the software architecture, which relates to machine learning engineering. In the disclosed embodiment, the data processed through the data wrangling phase can be sent to the model trainer for the model training phase. The model trainer module can be implemented with respect to the forecast trainer modules depicted through FIG. 2-4.

The model trainer module subsequently has the option to transform the data through a trained neural network to a model validation phase. A predictor module can be implemented to generate the functions for validating the models trained from the previous phase. Once validated, the output can be generated as evaluation metrics that can be used for further forecast and predicative analytical functions.

### Exemplary Cloud Architecture

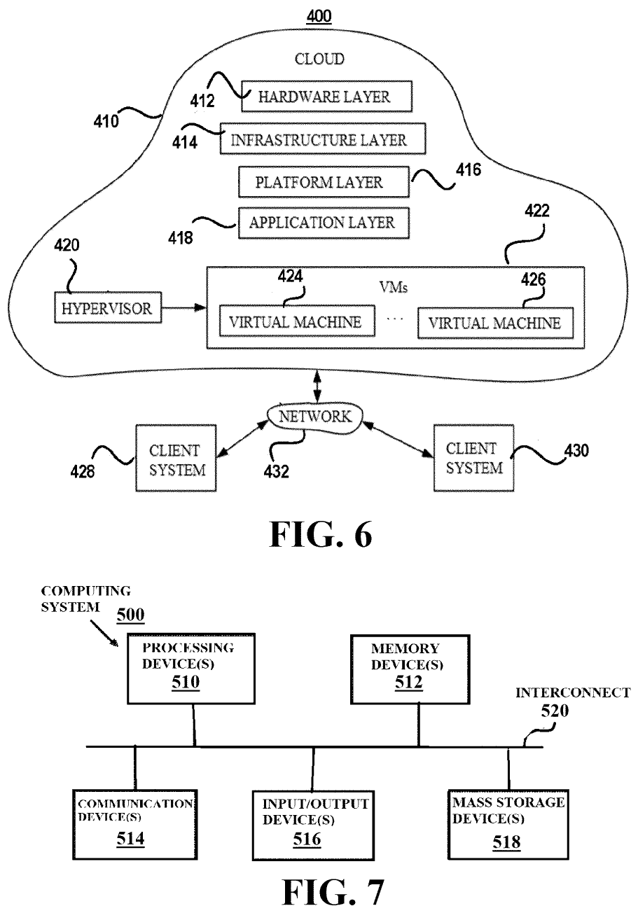

Referring to FIG. 6 with continuing reference to the foregoing figures, exemplary cloud architecture, generally designated by the numeral 400, for implementing the system 100 shown in FIG. 1. The architecture 400 can be used to perform the processes 200, 210, and 220 shown in FIGS. 2-4. The structure 300 shown in FIG. 5 can be implemented with this architecture 400. The exemplary cloud architecture 400 provides computation, software, data access, and storage services that do not require end-user knowledge of the physical location or configuration of the system that delivers the services. In various embodiments, cloud computing delivers the services over a wide area network, such as the internet, using appropriate protocols.

For instance, cloud computing providers deliver applications over a wide area network and they can be accessed through a web browser or any other computing component. Software or components of architecture 400 as well as the corresponding data, can be stored on servers at a remote location. The computing resources in a cloud computing environment can be consolidated at a remote data center location or they can be dispersed. Cloud computing infrastructures can deliver services through shared data centers, even though they appear as a single point of access for the user. Thus, the components and functions described herein can be provided from a service provider at a remote location using a cloud computing architecture. Alternatively, they can be provided from a conventional server, or they can be installed on client devices directly, or in other ways.

The description is intended to include both public cloud computing and private cloud computing. Cloud computing (both public and private) provides substantially seamless pooling of resources, as well as a reduced need to manage and configure underlying hardware infrastructure.

A public cloud is managed by a vendor and typically supports multiple consumers using the same infrastructure. Also, a public cloud, as opposed to a private cloud, can free up the end users from managing the hardware. A private cloud can be managed by the organization itself and the infrastructure is typically not shared with other organizations. The organization still maintains the hardware to some extent, such as installations and repairs, etc.

As shown in FIG. 6, the cloud architecture 400 includes a cloud 410. The cloud 410 (or each of the different premises on the cloud 410) can include a hardware layer 412, an infrastructure layer 414, a platform layer 416, and an application layer 418.

A hypervisor 420 can illustratively manage or supervise a set of virtual machines 422 that can include a plurality of different, independent, virtual machines 424-426. Each virtual machine can illustratively be an isolated software container that has an operating system and an application inside it. It is illustratively decoupled from its host server by hypervisor 420. In addition, hypervisor 420 can spin up additional virtual machines or close virtual machines, based upon workload or other processing criteria.

A plurality of different client systems 428-430 (which can be end user systems or administrator systems, or both) can illustratively access cloud 410 over a network 432. Depending upon the type of service being used by each of the client systems 428-430, cloud 410 can provide different levels of service. In one example, the users of the client systems are provided access to application software and databases. The cloud service then manages the infrastructure and platforms that run the application. This can be referred to as software as a service (or SaaS). The software providers operate application software in application layer 418 and end users access the software through the different client systems 428-430.

The cloud provider can also use platform layer 416 to provide a platform as a service (PaaS). This involves an operating system, programming language execution environment, database and webserver being provided to the client systems 428-430, as a service, from the cloud provider. Application developers then normally develop and run software applications on that cloud platform and the cloud provider manages the underlying hardware and infrastructure and software layers.

The cloud provider can also use infrastructure layer 414 to provide infrastructure as a service (IaaS). In such a service, physical or virtual machines and other resources are provided by the cloud provider, as a service. These resources are provided, on-demand, by the IaaS cloud provider, from large pools installed in data centers. In order to deploy the applications, the cloud users that use IaaS install operating-system images and application software on the cloud infrastructure 400.

### Exemplary Computer System

Referring now to FIG. 7 with continuing reference to the forgoing figures, an exemplary computing system, generally designated by the numeral 500, for use in implementing the system 100 shown in FIG. 1 is shown. The computer system 500 can be used to perform aspects of the processes 200, 210, and 220 shown in FIGS. 2-4. Aspects of the structure 300 shown in FIG. 5 can be implemented with the computer system 500.

The hardware architecture of the computing system 500 that can be used to implement any one or more of the functional components described herein. In some embodiments, one or multiple instances of the computing system 500 can be used to implement the techniques described herein, where multiple such instances can be coupled to each other via one or more networks.

The illustrated computing system 500 includes one or more processing devices 510, one or more memory devices 512, one or more communication devices 514, one or more input/output (I/O) devices 516, and one or more mass storage devices 518, all coupled to each other through an interconnect 520. The interconnect 520 can be or include one or more conductive traces, buses, point-to-point connections, controllers, adapters, and/or other conventional connection devices. Each of the processing devices 510 controls, at least in part, the overall operation of the processing of the computing system 500 and can be or include, for example, one or more general-purpose programmable microprocessors, digital signal processors (DSPs), mobile application processors, microcontrollers, application-specific integrated circuits (ASICs), programmable gate arrays (PGAs), or the like, or a combination of such devices.

Each of the memory devices 512 can be or include one or more physical storage devices, which can be in the form of random-access memory (RAM), read-only memory (ROM) (which can be erasable and programmable), flash memory, miniature hard disk drive, or other suitable type of storage device, or a combination of such devices. Each mass storage device 518 can be or include one or more hard drives, digital versatile disks (DVDs), flash memories, or the like. Each memory device 512 and/or mass storage device 518 can store (individually or collectively) data and instructions that configure the processing device(s) 510 to execute operations to implement the techniques described above.

Each communication device 514 can be or include, for example, an Ethernet adapter, cable modem, Wi-Fi adapter, cellular transceiver, baseband processor, Bluetooth or Bluetooth Low Energy (BLE) transceiver, serial communication device, or the like, or a combination thereof. Depending on the specific nature and purpose of the processing devices 510, each I/O device 516 can be or include a device such as a display (which can be a touch screen display), audio speaker, keyboard, mouse or other pointing device, microphone, camera, etc. Note, however, that such I/O devices 516 can be unnecessary if the processing device 510 is embodied solely as a server computer.

In the case of a client device, the communication devices(s) 514 can be or include, for example, a cellular telecommunications transceiver (e.g., 3G, LTE/4G, 5G), Wi-Fi transceiver, baseband processor, Bluetooth or BLE transceiver, or the like, or a combination thereof. In the case of a server, the communication device(s) 514 can be or include, for example, any of the aforementioned types of communication devices, a wired Ethernet adapter, cable modem, DSL modem, or the like, or a combination of such devices.

A software program or algorithm, when referred to as “implemented in a computer-readable storage medium,” includes computer-readable instructions stored in a memory device (e.g., memory device(s) 512). A processor (e.g., processing device(s) 510) is “configured to execute a software program” when at least one value associated with the software program is stored in a register that is readable by the processor. In some embodiments, routines executed to implement the disclosed techniques can be implemented as part of OS software (e.g., MICROSOFT WINDOWS® and LINUX®) or a specific software application, algorithm component, program, object, module, or sequence of instructions referred to as “computer programs.”

Computer programs typically comprise one or more instructions set at various times in various memory devices of a computing device, which, when read and executed by at least one processor (e.g., processing device(s) 510), will cause a computing device to execute functions involving the disclosed techniques. In some embodiments, a carrier containing the aforementioned computer program product is provided. The carrier is one of an electronic signal, an optical signal, a radio signal, or a non-transitory computer-readable storage medium (e.g., the memory device(s) 512).

The detailed description provided above in connection with the appended drawings is intended as a description of examples and is not intended to represent the only forms in which the present examples can be constructed or utilized.

It is to be understood that the configurations and/or approaches described herein are exemplary in nature, and that the described embodiments, implementations and/or examples are not to be considered in a limiting sense, because numerous variations are possible.

The specific processes or methods described herein can represent one or more of any number of processing strategies. As such, various operations illustrated and/or described can be performed in the sequence illustrated and/or described, in other sequences, in parallel, or omitted. Likewise, the order of the above-described processes can be changed.

Although the subject matter has been described in language specific to structural features and/or methodological acts, it is to be understood that the subject matter defined in the appended claims is not necessarily limited to the specific features or acts described above. Rather, the specific features and acts described above are presented as example forms of implementing the claims.

### Supported Features and Embodiments

The detailed description provided above in connection with the appended drawings explicitly describes and supports various features of an energy resource distribution system. By way of illustration and not limitation, supported embodiments include an energy resource distribution management system with predicative analysis capabilities, comprising: an energy resource distribution management system engine that is implemented with optimal power flow algorithm, at least one forecasting artificial neural network module, and at least one database, wherein the database comprises a historical database and an application specific database, wherein the forecasting artificial neural network module performs mathematical modeling on data received from the database to generate at least one forecasted data.

Supported embodiments include the foregoing system, wherein the at least one artificial neural network is configured to generate forecast data based on training data, model structural parameters, and learning algorithm parameters.

Supported embodiments include any of the foregoing systems, wherein the at least one artificial neural network is configured for PV generation forecast.

Supported embodiments include any of the foregoing systems, wherein the at least one artificial neural network is configured for electric vehicle demand and generation forecast.

Supported embodiments include any of the foregoing systems, wherein the at least one artificial neural network is configured for electric load forecast.

Supported embodiments include a method for forecasting energy resource distribution, comprising: implementing an energy resource distribution management system engine with optimal power flow algorithm, connecting the engine to at least one forecasting artificial neural network module, connecting at least one database, wherein the database comprises a historical database and an application specific database, to the engine, and utilizing mathematical modeling on data received from the database to generate at least one forecasted data.

Supported embodiments include the foregoing method, wherein the at least one artificial neural network is configured to generate forecast data based on training data, model structural parameters, and learning algorithm parameters.

Supported embodiments include any of the foregoing methods, wherein the at least one artificial neural network is configured for PV generation forecast.

Supported embodiments include any of the foregoing methods, wherein the at least one artificial neural network is configured for electric vehicle demand and generation forecast.

Supported embodiments include any of the foregoing methods, wherein the at least one artificial neural network is configured for electric load forecast.

Supported embodiments include an apparatus, a device, a computer-readable storage medium, a computer program product and/or means for implementing any of the foregoing systems, methods, or portions thereof.

The detailed description provided above in connection with the appended drawings is intended as a description of examples and is not intended to represent the only forms in which the present examples can be constructed or utilized.

It is to be understood that the configurations and/or approaches described herein are exemplary in nature, and that the described embodiments, implementations and/or examples are not to be considered in a limiting sense, because numerous variations are possible.

The specific processes or methods described herein can represent one or more of any number of processing strategies. As such, various operations illustrated and/or described can be performed in the sequence illustrated and/or described, in other sequences, in parallel, or omitted. Likewise, the order of the above-described processes can be changed.

Although the subject matter has been described in language specific to structural features and/or methodological acts, it is to be understood that the subject matter defined in the appended claims is not necessarily limited to the specific features or acts described above. Rather, the specific features and acts described above are presented as example forms of implementing the claims.

What is claimed is:

1. An energy resource distribution management system with predicative analysis capabilities comprising:
an energy resource distribution management system engine that is implemented with optimal power flow algorithm,
at least one forecasting artificial neural network module, and
at least one database, wherein the database comprises a historical database and an application specific database,
wherein the forecasting artificial neural network module performs mathematical modeling on data received from the database to generate at least one forecasted data.

2. The system of claim 1, wherein the at least one artificial neural network is configured to generate forecast data based on training data, model structural parameters, and learning algorithm parameters.

3. The system of claim 1, wherein the at least one artificial neural network is configured for PV generation forecast.

4. The system of claim 1, wherein the at least one artificial neural network is configured for electric vehicle demand and generation forecast.

5. The system of claim 1, wherein the at least one artificial neural network is configured for electric load forecast.

6. A method for forecasting energy resource distributions comprising:
implementing an energy resource distribution management system engine with optimal power flow algorithm,
connecting the engine to at least one forecasting artificial neural network module,
connecting at least one database, wherein the database comprises a historical database and an application specific database, to the engine, and
utilizing mathematical modeling on data received from the database to generate at least one forecasted data.

7. The method of claim 6, wherein the at least one artificial neural network is configured to generate forecast data based on training data, model structural parameters, and learning algorithm parameters.

8. The method of claim 6, wherein the at least one artificial neural network is configured for photovoltaic generation forecast.

9. The method of claim 6, wherein the at least one artificial neural network is configured for electric vehicle demand and generation forecast.

10. The method of claim 6, wherein the at least one artificial neural network is configured for electric load forecast.
